(19) United States
(12) Patent Application Publication
(10) Pub. No.: US 2006/0289074 A1
(43) Pub. Date: Dec. 28, 2006

(54) Pipe with a canal in the pipe wall

(75) Inventors: Magnus Eriksson, Trondheim (NO); Sigbjorn Sangesland, Trondheim (NO); Anders Sundgren, Sodra Sunderbyn (SE)

Correspondence Address: ROTHWELL, FIGG, ERNST & MANBECK, P.C., 1425 K STREET, N.W., SUITE 800, WASHINGTON, DC, 20005, US

(73) Assignee: NTNU TECHNOLOGY TRANSFER AS, Trondheim (NO)

(21) Appl. No.: 11/474,284

(22) Filed: Jun. 26, 2006

(30) Foreign Application Priority Data
Jun. 27, 2005 (NO) NO20053140

(51) Int. Cl. F16L 9/00

(52) U.S. Cl. 138/171; 29/417

(57) ABSTRACT

A method for the manufacture of a pipe (1) for use in petroleum exploitation, the manufacturing process comprising roll-forming of a steel plate (11) to form a hollow (0′) with a longitudinal gap for being welded to form said pipe (1), the method characterized by the following steps:
said steel plate (11) having lateral edge surfaces (221, 222),
in which along on or more of said lateral edge surfaces (221, 222) are formed longitudinal grooves (22, 22′) thus forming first bridge parts (23, 23′) comprising a first lateral edge surface (221i, 222i) along a first side of said groove (22, 22′), and
thus forming a second lateral edge surface (221y, 222y) on a second side of said groove (22, 22′);
welding of said first bridge parts' (23, 23′) first lateral edge surfaces (221i, 222i), thereby joining said grooves (22, 22′)
joining said second lateral edge surfaces (221y, 222y) to form a lid (3) to cover said grooves (22, 22′) to form a canal (2) in the wall of said pipe (1).

### BACKGROUND OF THE INVENTION

1. Field of the Invention

The present invention relates to a pipe for use in work related to petroleum exploitation, for instance a drilling pipe, such that a canal in the pipe wall is arranged for containing one or more electrical or optical conductors or hydraulic pipes, or in which the pipe canal in itself is arranged for forming a hydraulic conduit or electromagnetic conductor. More specifically, it relates to a method for forming a longitudinally extending canal in an extended steel plate during a roll-forming process for the manufacture of a pipe, and such a roll-formed pipe.

2. Problems to be Addressed

Petroleum Technology Problem:

When drilling for oil or gas there is a desire to transmit information through the pipes between the drilling bit and the drilling installation on the surface. This is for enabling the performance of real time seismic, electrical, magnetic or other geophysical measurements and thus drill for petroleum fluids in a more efficient manner. More efficient drilling may increase the yield. Mud pulse telemetry is limited to approximately 12 bits/second and is routinely performed according to the background art. Such a slow signal transmission necessitates the selective transmission of small amounts of data, for instance averaged measurements of downhole parameters such as pressure, temperature, drilling direction, hole stability, friction conditions, rotational speed, moments and weight-on-bit, LWD measurements, annular pressure, hole diameter, drilling string vibrations etc. If one could have an electrical or optical conductor extending from the surface down to the drilling bit, one would be able to achieve two-way real time communication having signal transmission speeds of for instance 1 Mbit/sec. This may imply quicker and safer drilling operations for instance with quick detection of sudden inflow of formation fluids into the well and thus uncontrollable or undesired situations may be avoided. To communicate between the drilling bit and the drilling installation, for instance a drilling platform at sea, some other kind of communication conduit is needed between the above. A different need for communication is to monitor measurements conducted on the drilling string itself, for instance to transmit information pertaining to the rotational speed of the drilling bit, about undesired vibrations or pertaining to fluid flow conditions. One solution is found by means of using a loose cable that lies sequentially in the approximately 10 metre long drilling pipes. Between the couplings is formed an inductive transmission for the signal from the conductor in one pipe to the conductor in a next pipe. A loose cable within the pipe has major disadvantages as the cable is subjected to mechanical strains and erosion and further that it may hinder the transport of mud. A solution with a cable in the main bore of the pipe string does not function in a satisfactory manner and it is desirable to be able to arrange the signal cable within a longitudinal pipe-shaped canal in the pipes shell or pipe wall, in which the pipe-shaped canal has a diameter of approximately 3 mm into which a cable may be inserted or drawn.

Technical Problems Related to Materials.

A drilling pipe according to a preferred embodiment of the invention in which the pipe is roll-formed will have a higher strength-to-weight ratio compared to drilling pipes of the known kind which are produced by forcing a mandrel through the pipe and subsequent heat treatment and subsequent friction welding of threaded end pieces. Using the friction welding of the tooijoints as used today for instance by Grant Prideco, it will be difficult to maintain possible pipe canals in the main section of the drilling pipes, and also the pipe canals possible transition to the tooljoint.

Important tensile properties of some kinds of drilling pipes in use today are:

| Tensile | | Degree (kind of drilling pipe) | | | | |
|---|---|---|---|---|---|---|
| properties | Unit | D | E | X96 | G105 | S135 |
| Minimum | MPa | 379 | 517 | 665 | 724 | 931 |
| yield stress | | | | | | |
| Maxsimum | MPa | — | 724 | 861 | 930 | 1138 |
| yield stress | | | | | | |
| Minimum | MPa | 655 | 689 | 758 | 793 | 1000 |
| tensile strength | | | | | | |
| Elongation (1) | % | 19.5 | 18.5 | 17.0 | 16.0 | 13.5 |
| Average yield | MPa | 448 | 586 | 758 | 827 | 1000 |
| stress | | | | | | |

(1) Formula given in API std 5A: e = 625000 × A^{0,2}/U^{0,9}
in which:
A = Cross section area (sq. Inch)
U = Specified tensile strength (psi)
E = minimum elongation in 2″ length (%)

The state of the art is thus a yield stress limit of 930 MPa (Drilling pipe S135). A drilling pipe produced according to the invention will in addition to comprising a canal in the pipe wall further have a higher yield stress limit, generally 1100 MPa. This represents an 18% increase in strength or about 15% reduction in weight, in principle a potential 15% increase in drilling length with respect to conventional drilling pipes.

### BACKGROUND ART IN THE FIELD

Examples of background art having an electrical signal conductor in a drilling pipe is given in the following patent publications.

European patent application EP136297 “Tubing containing electrical wiring insert” comprises double pipes in which an inner pipe is furnished with a longitudinal furrow towards the outer pipe through which a wire may be drawn for data or power transmission.

U.S. Pat. No. 4,496,203 “Drill pipe sections” describes a drilling pipe having an electrically insulated cylindrical inner part in a pipe housing. A longitudinal furrow is arranged in the inner portion with space for an electrical conductor. No mention is made of welding the steel pipe to achieve a canal along the pipe wall.

U.S. Pat. No. 5,217,071 “Production tube with integrated hydraulic line” describes a pipe element for production pipes having an integrated hydraulic pipe in the inner surface of the production pipe. Thus the resulting pipe much resembles the product of the method of the present application. Claim 1 of the US-patent, in the same manner as the present product pertains to a furrow along the surface of the outer peripheral surface of a (steel) pipe, but in which said furrow is provided with a pipe and said pipe is surrounded by a filler material, in practice soldering metal. A major disadvantage of the US-patents pipe is the wall thickness, see U.S. Pat. No. 5,217,071, col. 2 lines 55-61: “In order to conform to safety standards, the thickness -D- of the element 26 or 28 which is delimited by the bottom of the groove 28 corresponds to the thickness of a production tube of the conventional type” This means that the tube will be unnecessarily thick compared to it's strength, (or unnecessarily weak compared to it's thickness). Thus we may say that the present invention has a major advantage with respect to mechanical strength compared to this US-patent. Said US patent specifically describes a hydraulic pipe arranged in filler material without further mechanically strong coverage in the pipe wall.

U.S. Pat. No. 6,717,501 “Downhole data transmission system” shows in FIG. 15 (sheet 1/12) an inner longitudinal elevation on the pipe wall in which is arranged a longitudinal pipe within the elevation. The US patent describes in particular the transition and the threaded portion between a pipe and the consecutive pipe, in which is arranged ring-shaped surfaces for the transmission of fluids from one hydraulic pipe canal to the next. However, the patent claims pertain to a system for sending data through a series of downhole components, in which emphasis is put on the geometry of the threaded portions in the transition between one pipe to a next, and none on the production methodology for the canal of the pipe wall.

U.S. Pat. No. 6,830,467 “Electrical transmission line diametrical retainer” Dec. 14, 2004 pertains to a method for keeping an electrical conductor in place in a canal in the pipe wall, and in particular at the ends/transitions in the threaded portion between one pipe and the next.

US patent application 2004/020651 describes a method for inserting an electrical conductor in a furrow in the outer surface of the drilling pipe (see the US application's FIG. 2a, 2b) during the drilling process. US patent application 2004/0206511 is relevant as it pertains to the use of a longitudinal trace in the outer wall of a pipe, but does not relate to the production of the drilling pipe. The US patent application describes the pipe having threads in both ends being used as a casing pipe in so-called “drilling with casing” operations in which an electrical or optical conductor is fed from a reel below the drilling deck and into the furrow little by little as the drilling rig lowers the casing down through the spider in the drilling deck, without rotating the casing pipe. On page 5 of the US patent application 2004/0206511 left column section [0049] is described that a mud driven motor is used in which only the drilling bit rotates. US patent application 2004/0206511 thus does not describe any rotating drilling pipe and it is obvious from the description and the open trace that rotation of the pipe string would destroy the electrical or optical conductor in the trace of the drilling pipe.

US patent application US2004/0200881 describes the production of a pipe by cold-rolling to a pipe-shaped hollow-body and welding and working of the weld seam to provide a homogeneous structure to the welded pipe wall, see FIG. 1 in the US-patent application for a process outline. However US '881 specifies several steps which are not incorporated in the method of the present invention, a substantial difference being: welding the hollow along the longitudinal seam region using a tungsten inert gas or plasma welding process, achieving complete weld penetration through the wall thickness of the hollow with a similar filler material or like chemistry of the parent material or without the use of filler material”. In the present application a complete weld-penetration is not used, or a burn through of the wall thickness in the hollow body that is welded together to form a pipe. Nor is in the preferred embodiment any solder added. A further substantial step of US '881 is “cold work the welded low yield and tensile strengths hollow to reduce the welded hollow in wall thickness and in outer and inner diameters, thereby producing a high yield and tensile strengths cold worked pipe”. In the present application so-called cold working of the produced pipe to change the wall thickness is not used. Furthermore, the process of US '881 does not result in a canal in the pipe wall.

U.S. Pat. No. 5,997,045 “Pipe joint” describes pipe couplings between pipes with longitudinal pipe canals, at least through the end sections (for short pipes), having a transition from a pipe canal in the end section through the pipe coupling to a pipe canal arranged in a recession in the pipe wall for pipes that are so elongate as to not be able to be drilled through. The inventors of US-'045 have thus not envisaged a solution according to the present application having a longitudinal pipe canal made in the pipe wall through the entire length of the pipe. The present invention thus rebuts a prejudice in the known art that it is not feasible to form a deep-lying pipe canal in an otherwise homogeneous pipe wall.

Manufacturing of a drilling pipe for the drilling for oil and gas may be performed using the following known art:
a) Deep drawing of a so-called “green pipe” by mandrel drawing to achieve a pipe having a massive wall.
b) Upsetting the pipe
c) Austenitizing of the pipe
d) rapid cooling of the pipe
e) heat-treatment of the pipe
f) rectification of the pipe
g) friction welding of the pipe to prefabricated connectors by rotation and pressing of the end-section against the end of the pipe. This has a major disadvantage: the rotational welding furnishes much heat energy to the drilling pipe and the coupling joint, and also occurrence a melted or deformed material excess. Furthermore the rotation-friction welding will, according to the present state of the art, destroy a possible pipe canal in the wall of the drilling pipe, and would not align a pipe canal in the pipe stem itself and a pipe canal in the coupling joint.

When drilling for oil according to the present state of the art with measurements being performed during drilling, the rate of advance is limited in that one must monitor the drilling bits and the torque and drag of the drilling pipe, and compare these to the forces and moments which the pipe strings is subjected to from the drilling rig. The signal speed of mud pulse technology is low, often 12 bit/second. If one uses a drilling pipe according to the invention having high capacity instantaneous signal transmission through a conductor or optical fibre from sensors at the drilling bit, one may increase the possibility of preserving the bit by taking into account those changes which occur at the drilling bit, and thus simultaneously avoid twisting off or fatiguing the drilling pipe.

Thus the known production methods for pipes do not result in pipes that are sufficiently light and have both a high enough tensile strength and braking strength and at the same time contains a pipe canal in the pipe wall arranged for containing an electrical or optical signal or energy conductor such as for instance an electrical cable or optical fibre bundle. Those drilling pipes having a canal for an electrical or optical conductor are either weakened or unsuitable for the ordinary drilling with rapid signal transmission of which the present invention renders possible.

### BRIEF DESCRIPTION OF THE DRAWINGS

The invention is illustrated in the attached drawing figures. The illustrations are meant to illustrate preferred and alternate embodiments of the invention, and shall not be construed to limit the scope of the invention which shall solely be limited by the attached patent claims.

FIG. 1 illustrates a cross-section of a part of a pipe wall of for instance a drilling pipe in which a deep groove or furrow is formed along the pipes outer surface, in which the groove shall be closed to form a pipe canal along the pipe wall. A such pipe may according to an embodiment of the invention be part of a pipe string for oil production and with a such canal in the pipe wall the pipe string may be arranged for containing an energy or signal cable in the pipe canal such that that the cable may transmit measurement signals from down in the bore hole and up to the surface at the same time as the main bore of the pipe may be used in the normal manner for pumping down mud to cool the pipe string and the bore hole, lubricate the pipe string, pressure compensate for hydrostatic and lithostatic pressure in the bore hole, chemically balance the bore hole and transport bore cuttings to the surface without coming into conflict with the energy and signal line in the pipe canal.

FIG. 1A illustrates in perspective a steel plate on a reel, and the initial steps in the roll-forming of a steel plate to an incipient hollow-body.

FIG. 1B shows in perspective view the continuation of the roll-forming of the hollow-body until the hollow-body is almost pipe-shaped with adjoining plate edges that are welded together and form a pipe.

FIG. 1C sketches a cross-section view of the welding of the hollow-body into a pipe. In this preferred embodiment of the invention, the lateral edges of the plate are shaped for the preforming of a groove in which the first and radially inner weld ends up in the middle of the bottom surface.

FIG. 1D shows an enlarged portion around the radially inner weld lying in the centre of the groove that shall later form the bottom of the pipe canal.

FIG. 2 in the same manner illustrates a cross-section of a part of the pipe wall according to a first preferred embodiment of a pipe according to the invention. The groove is closed by arranging an elongate lid at least in an outer portion of the groove and welding the lid to the lateral edges such that a pipe canal is formed in the pipe wall.

FIG. 2A is a cross-section of the part of the welded pipe with the groove and illustrates that the lid is put into the groove along the pipe.

FIG. 2B is a similar cross-section that shows that the lid has become pressed into place and in which the lateral edges of the lid are welded to the radially seen outer lateral edges of the groove, preferably by laser welding.

FIG. 2C shows a cross-section of the pipe wall with the pipe canal with the lid in three alternate embodiments with a concave inner surface. If the lid is formed having a concave inner surface, deep lateral surfaces of the lid are formed allowing the formation of a deeper weld seam by laser welding. The concave inner surface of the lid may be formed in several manners as shown. In a first embodiment of the invention a compass roof over the entire breadth of the groove, and the radially seen inner lateral edges align with the lateral edges of the bottom of the groove that preferably may be shaped as a half-pipe. In a second embodiment the lids curved lower surface may be somewhat narrower and be furnished with “shoulders” abutting against similar shoulders in the bottom of the groove. In this way a root support for the laser weld is formed and one may allow to burn slightly deeper than the shoulder in the bottom of the lateral edge of the groove, a weld that may anyhow be toughened out by subsequent heat-treatment and toughening. Two embodiments of the bottom are shown, one flat and one shaped as a half-pipe having shoulders corresponding to the shoulders at the lower edge of the inner surface of the lid.

FIG. 3 illustrates in a perspective cross-section of a part of the pipe wall according to the invention in which the lid is welded into the groove and forms the canal and in which the pipe wall and the welds are forged and toughened and in which the thickness of the material over the cross-section of the pipe canal is generally equal to the thickness of the material of the cross-section of the pipe wall to the side of the pipe canal.

FIG. 3A illustrates the continuation of the process from FIG. 2B in which the weld shut and preferably also the lid and the pipe has been subject to heat treatment and hardened so as for the welds to be hardened out to have generally the same microstructure as the adjacent portions of the pipe wall.

FIG. 4 illustrates the main stem of a pipe according to the invention, having a main bore according to the known art and with a pipe canal formed in the pipe wall, in which the steel material that is radially counted at the inside and the material at the outside of the pipe canal is the same and equal to the material in the remainder of the pipe wall. In the illustrated embodiment of the invention the sum of the wall thickness is generally the same in the section across the pipe canal and across the remainder of the pipe wall.

FIG. 5 shows a cross-section and partial outline of a pipe as a particular embodiment of the invention, having a pipe canal in the pipe wall and mounted tooljoints, and having signal couplings, for instance inductive couplings arranged in the coupling pieces.

FIG. 6 are illustrations of a first preferred embodiment of the invention comprising shaping of the lateral edges of the steel plate before roll-forming and first welding of the hollow-shaped steel plate into a pipe. FIG. 6a sketches upsetting the lateral edge surface until at least a lower portion forms a bulb at the lower edge of the plate which shall form a radially inner part of the weld seam of a pipe. FIG. 6B shows the upset plate in which is cut a “half” groove which in conjunction with it's reciprocal “half” groove shall form the groove that shall form the bottom of the pipe canal in the pipe wall.

FIG. 7 is a series of sketches of shaping at least one of the lateral edges of the steel plate for the formation of a “half” groove in the lateral edge before roll-forming of the steel plate into a hollow body and welding to a pipe with a pipe canal.

FIG. 7A shows splitting of the lateral edge of the plate for the formation of a groove with a future inner radial bridge part, and a future outer radial lid part.

FIG. 7B shows working and shaping of the radially inner bridge part such that it receives a radially inner lateral edge surface arranged for being welded to its counterpart formed on the opposite side of the steel plate.

FIG. 7C outlines a step after the roll-forming of the steel plate until it forms the hollow-body, in which is conducted welding, preferably laser welding of radially inner bridge parts inner lateral edge surface to its counterpart formed on the opposite side of the steel plate.

FIG. 7D sketches the shaping of the radially outer lid parts such that their end portions are shaped into future outer lateral edge surfaces arranged for being bent in towards the formed groove.

FIG. 7E shows the outer lid parts bent down such that their end surfaces form the steel plate's outer lateral edge surfaces, as counted radially, for welding to their counterparts for the enclosing of the groove to a pipe canal.

FIG. 7F illustrates heat-treatment and toughening of at least the weld seams and preferably the entire pipe comprising the pipe canal such that the entire pipe with the portion about the pipe canal obtains a mainly equal microstructure.

FIG. 8 is a perspective sketch of the end of a drilling pipe with a pipe canal according to the invention, in which the drilling pipe is to be welded to a tooijoint having a corresponding pipe canal in its wall. FIG. 8B is a cross-section and partial projection of a the end of drilling pipe with the tooljoint during the welding process, in which a weld seam (21e) is formed between the tooljoint and the end surface of the drilling pipe, and in which is prepared the welding of a short lid over the groove and the pipe canal in the transition between the pipe itself and the tooljoint.

FIG. 9 illustrates, in cross-section and in partial projection, a drilling pipe according to the invention in which is formed an inner, respectively outer conical concentric contact surfaces between the pipe part and the tooljoint so as for achieving a larger welding surface, either if this pertains to laser welding or to electromagnetic welding as sketched in FIG. 10.

FIG. 10 shows similarly to FIG. 9 a cross-section and partial perspective which illustrates conical contact surfaces between the pipe part and the tooljoint and electromagnetic welding of the pipe to the tooljoint, for instance by electrical discharge.

FIG. 11a-FIG. 11E shows production of a pipe having an even outer diameter and the possibility of inserting a cable into such a pipe, which may furnish a drilling pipe or coil tubing or other type of petroleum pipe providing considerable advantages.

FIG. 12a shows an alternative preferred embodiment of the invention comprising two steel plates to be joined before roll-forming to a tubular shape and welded to form a pipe.

FIG. 12b is equivalent to FIG. 12a, the difference between them being in FIG. 12b the roll-forming process occurs by bending the plates upwards, whereas in FIG. 12a the roll-forming occurs in a downwardly direction.

FIG. 13 shows more or less the same process as in FIGS. 12a and 12b, but in which the plates are not pre-shaped before the welding of the lateral edges of the adjacent steel plates.

FIG. 14 illustrates three additional alternative welding methods for forming a canal in a pipe wall.

FIGS. 14a1 and 14a2 are cross-sections perpendicular to the axis of the pipe or the longitudinal axis of the plate or plates, showing that both the inner and outer gap may be “V”-shaped and welded from one side using additive material.

FIG. 14b is a cross section as in FIG. 14a, illustrating that the adjacent lateral portions of the plate or plates about the adjacent furrows forming parts of the canal to be formed may formed as opposite “V”-shaped furrow sides to be welded using additive welding material from both sides of the plate.

FIG. 14c is an illustration of the combination of laser welding and conventional additive material welding. Tightly fitting inner lateral surfaces (221i, 222i) of lower bridge portions (23′, 23′) of the steel plate are laser welded below the formed furrows (22, 22′) using a laser (9) forming the welded zone (21i), and subsequently the outer lateral portions (221y, 222y) are welded using an additive material spanning the lateral portions (3′, 221y, 3′, 222y) to form a bridging lid portion (3) thus forming the desired canal (2) in the axial direction through the wall of the pipe formed. This embodiment of the invention may be useful if the canal along the axial direction of the plate shall be formed after to the roll-forming process.

FIG. 14d is an illustration of a joint of the two lateral surfaces having two weld seams symmetrically arranged about the so formed canal (2).

FIGS. 15a, b, c, and d illustrates four different cross-sections of parts of pipes according to the invention.

FIG. 16 illustrates calculated Hoop stress distributions about a canal (2) in a pipe (1) as calculated using finite-element analyses. FIGS. 16a, b, c, and d are contour plots of hoop stress of sections of pipes corresponding to FIGS. 15a, b, c, and d. Please notice that the stress ranges change from one contour plot to another.

FIG. 17 illustrates calculated bending moment stress distributions about in a pipe (1) a with canal (2), calculated using finite-element analyses. FIGS. 17a, b, c, and d are contour plots of bending moment stress of sections of pipes corresponding to FIGS. 15a, b, c, and d.

FIG. 18 illustrates calculated torque stress distributions about in a pipe (1) a with canal (2), calculated using finite-element analyses. FIGS. 18a, b, c, and d are contour plots of torque stress of sections of pipes corresponding to FIGS. 15a, b, c, and d.

### SUMMARY OF THE INVENTION

The above mentioned problems in the known art may be remedied to a significant degree by the present invention, which is a method for forming a longitudinally extending canal in an extended steel plate during a roll-forming process for the manufacture of a pipe for use in petroleum exploitation, in which the new and characterizing features of this invention being the following steps:

forming a longitudinally extending groove in one or both of longitudinally extending, adjacent opposite lateral edge surfaces of said one or more steel plates to be joined, thus forming a first bridge part comprising a first lateral edge surface along a first side of said groove, and

thus forming a second lateral edge surface on a second, opposite side of said groove;

welding said first bridge parts' first lateral edge surface to said adjacent opposite lateral edge surface thereby making said one or more grooves constitute a bottom of said canal;

welding said second lateral edge surface to an opposite adjacent lateral edge surface to form a lid for bridging said one or more grooves to form said canal.

There are two main alternative embodiments of the method for producing a pipe with such a canal: One group of embodiments of the invention comprises forming the canal during forming a weld joint between two extending steel plates and the roll-forming of the so formed wider plate, and subsequently welding the back. Two extending steel plates are provided with said one or more grooves, and are welded together to form said canal along the joint in the so formed plate before roll-forming said plate to form a hollow with a longitudinal gap for being subsequently welded to form said pipe. Another group of embodiments of the invention comprises roll-forming an extending steel plate to a hollow and then forming the longitudinally extending canal in the pipe wall during the welding process of the gap in the hollow. In this process, said one or more steel plates is roll-formed to a hollow with a longitudinal gap provided with said one or more grooves, for being subsequently welded to form said pipe.

The invention further comprises a roll-formed pipe made from one or more steel plates for use in petroleum exploitation, the characterizing features said pipe comprising the following features:

a longitudinal pipe canal in the pipe wall, said pipe canal traversing a major proportion, preferably all, of the pipe's length,

a first, inner weld seam along said pipe canal, said weld seam adjoining inner lateral surfaces of said steel plates,

one or more bridge parts adjoining outer lateral surfaces thus covering said pipe canal at a radially counted outer surface of said pipe.

Further advantageous embodiments of the invention are defined in the attached dependent claims.

### DESCRIPTION OF PREFERRED EMBODIMENTS OF THE INVENTION

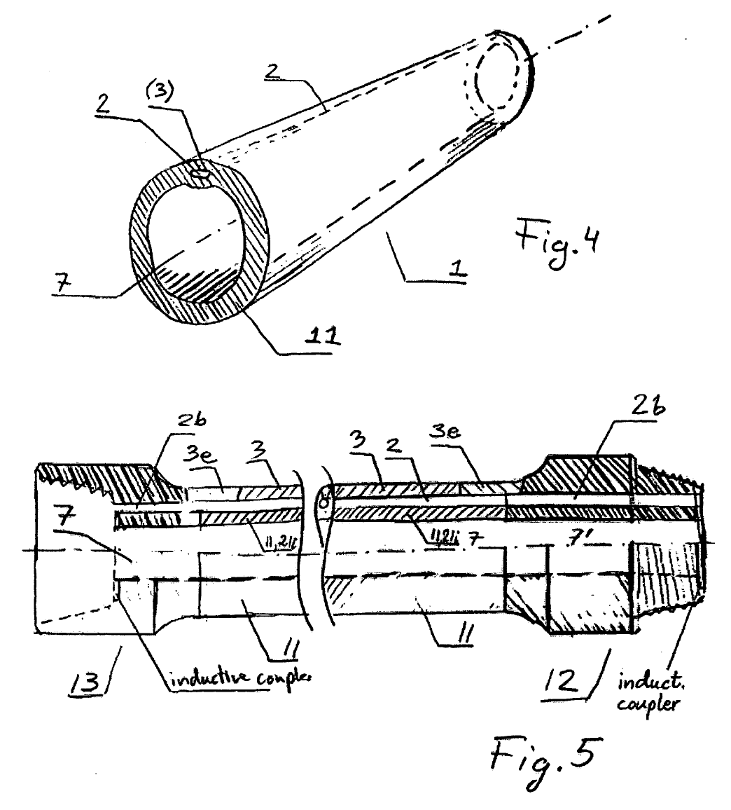

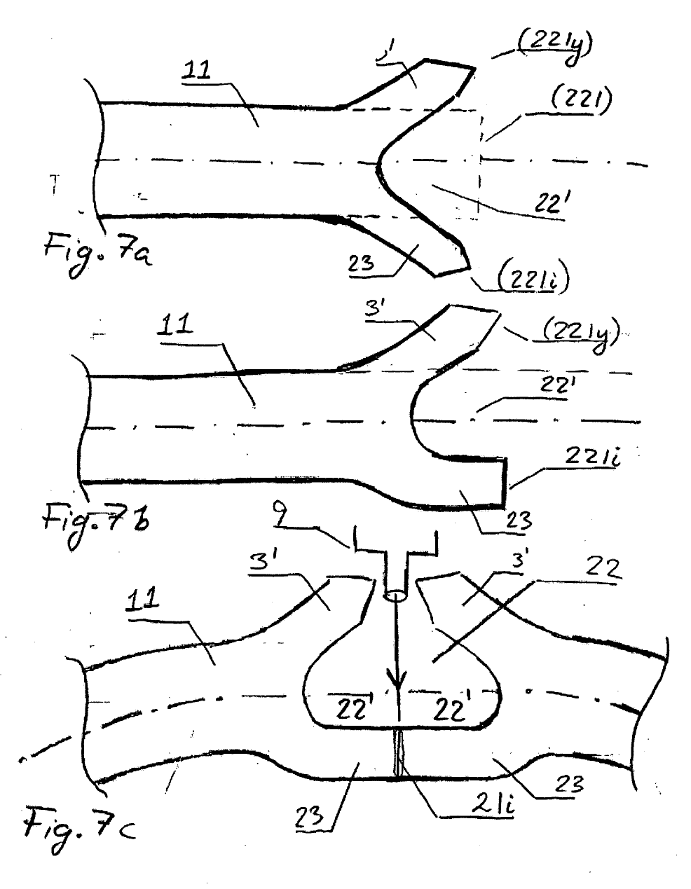

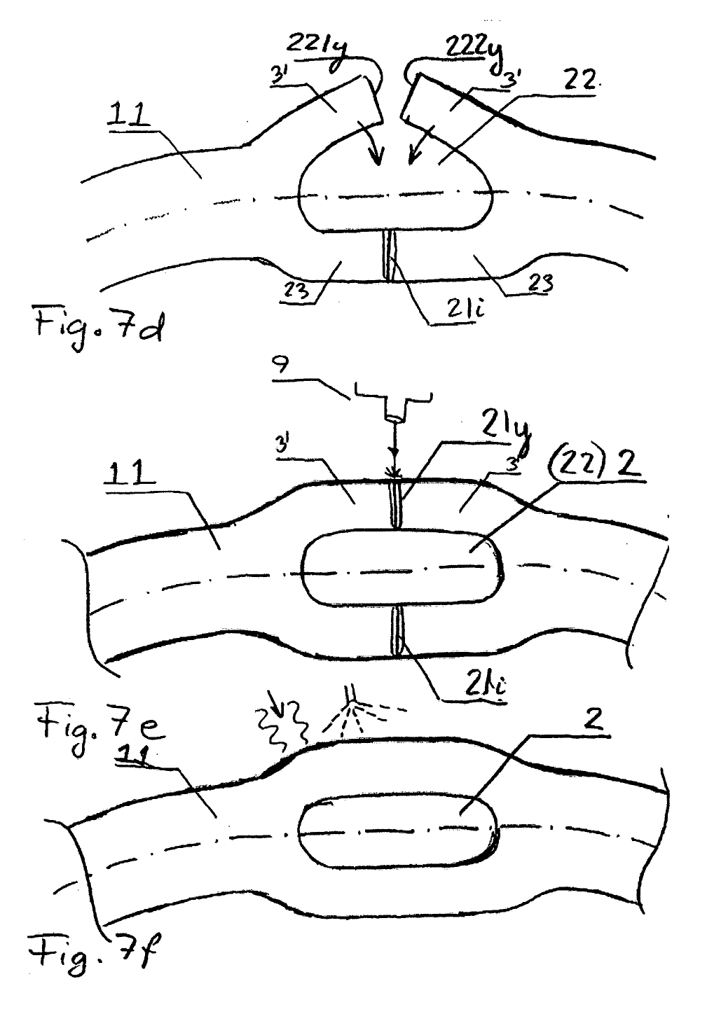

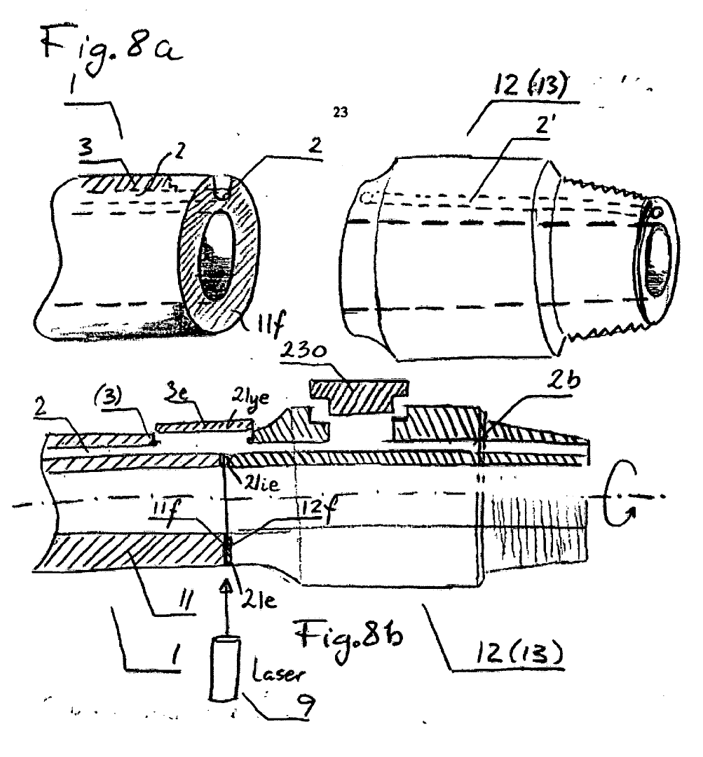

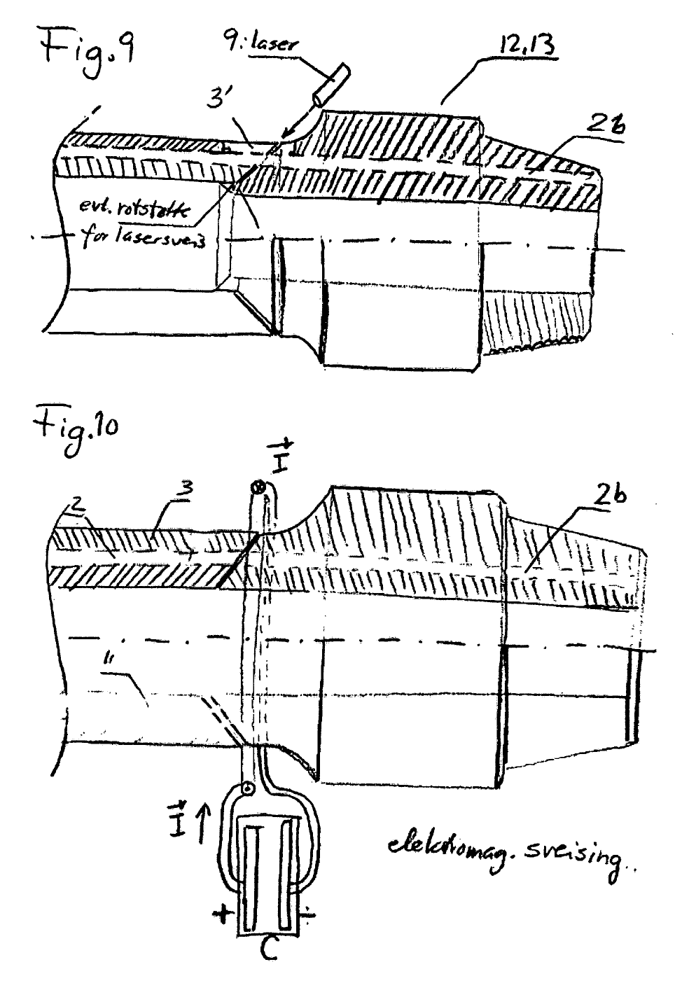

The present invention pertains to a method for producing a pipe (1) having a pipe canal (2) in the pipe wall for use in petroleum exploitation and such a pipe produced by the method. Examples of such pipes are drilling pipes and casing pipes/liners. The purpose of the pipe canal (2) in the pipe wall is to contain one or more signal conductors, for instance electrical or optical conductors for the transmission of electromagnetic signals or energy, or in which the canal in itself is an hydraulic pipe canal or electromagnetic wave guide, see FIG. 3 and FIG. 4, such that the pipe canal is arranged for protecting and containing a conductor for signals or energy between a first part of the pipe and a second part of the pipe.

The drilling pipe wall protects the electrical and optical conductors (4) in the pipe canal (2) against forces from drilling fluids, petroleum streams or cement in the pipe's main bore (7), and against chemical and mechanical erosion from drilling fluids, cuttings, the wall of the bore hole, cement and other in the annular space around the pipe. Signal conductors and energy conductors may be electrical, optical or hydraulic pipes.

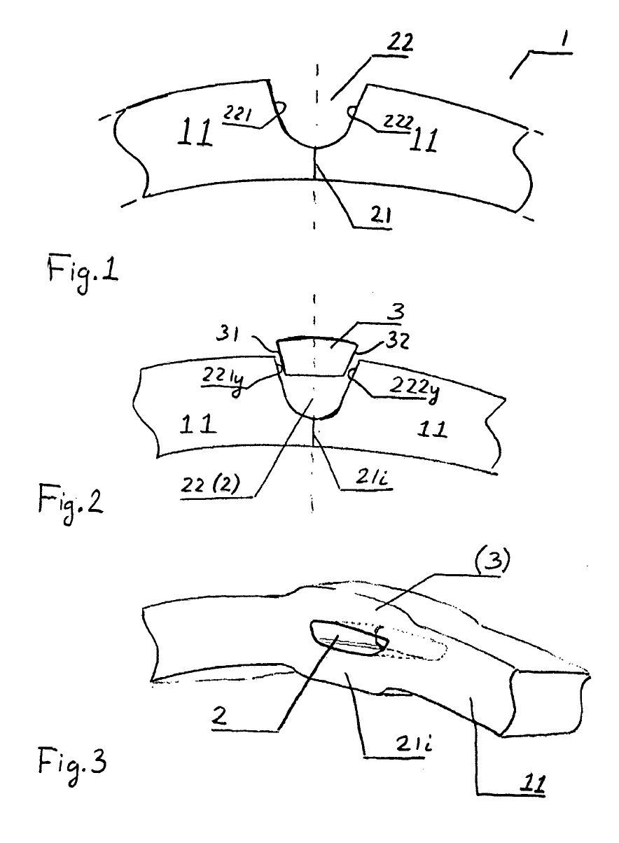

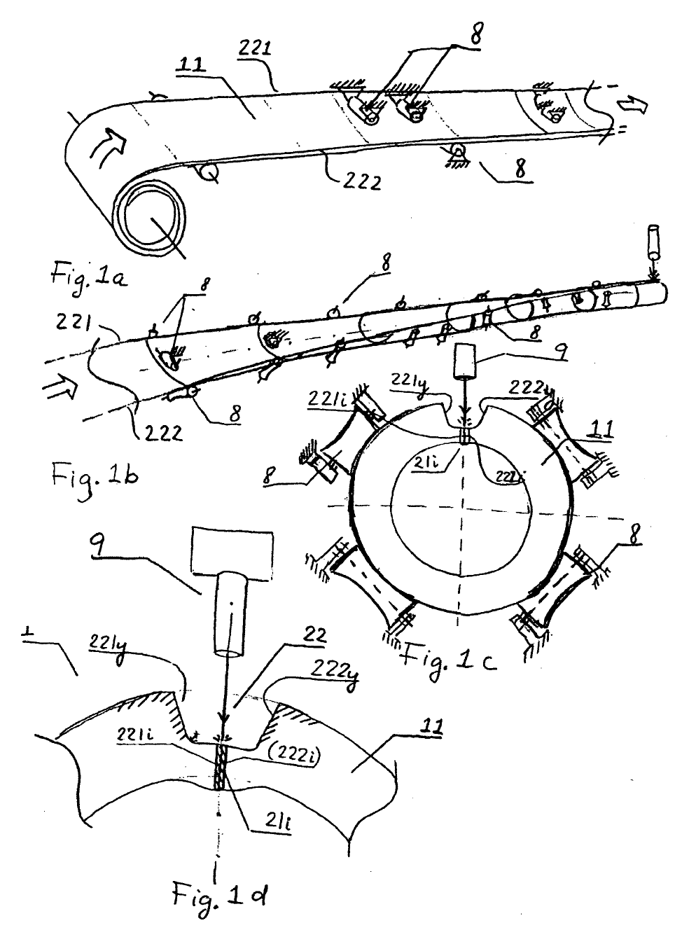

FIG. 1A illustrates in perspective a steel plate (11) on a reel and the initial steps in the roll-forming of a steel plate (11) by means of rollers (8) fixedly arranged along the path of the steel plate, until an initial hollow-body is formed.

FIG. 1B shows in perspective the continuation of the roll-forming of the hollow-body by means of inner convex and outer concave rollers (8) until the hollow body is almost pipe-shaped having adjoining plate lateral edge surfaces (221i, 222i) that are welded together to a weld seam (21i) and forms a pipe (1).

FIG. 1C sketches a cross-section of the welding of the hollow-body to a pipe. In this preferred embodiment of the invention the lateral edge surfaces (221,222) of the steel plate shaped for the prefabrication of a groove (22) in which the first and radially inner weld (21i) ends up mainly in the centre of the bottom surface of the groove (22).

According to a preferred embodiment of a method according to the invention the production of the pipe (1) itself is done using the following steps, see FIGS. 1a, 1b, 1c.

roll-forming of a length of a steel plate (11) with lateral edges (221,222) to a hollow body with a longitudinal gap formed by the lateral edges (221, 222),

welding of the lateral edges (221,222) in order to form a pipe (1), in which the welding of the pipes (1) wall (11) is conducted, see FIGS. 1c and 1D, by welding a seam (21i) that covers an inner part of the pipe wall's (11) thickness such that the longitudinal groove (22) in the radially seen outer surface of the pipe (1) is formed. FIG. 1d shows a cross-section of a part of the pipe wall 811) welded in the seam (21i). The welding may take place while using additive material, or take place by use of a laser (9).

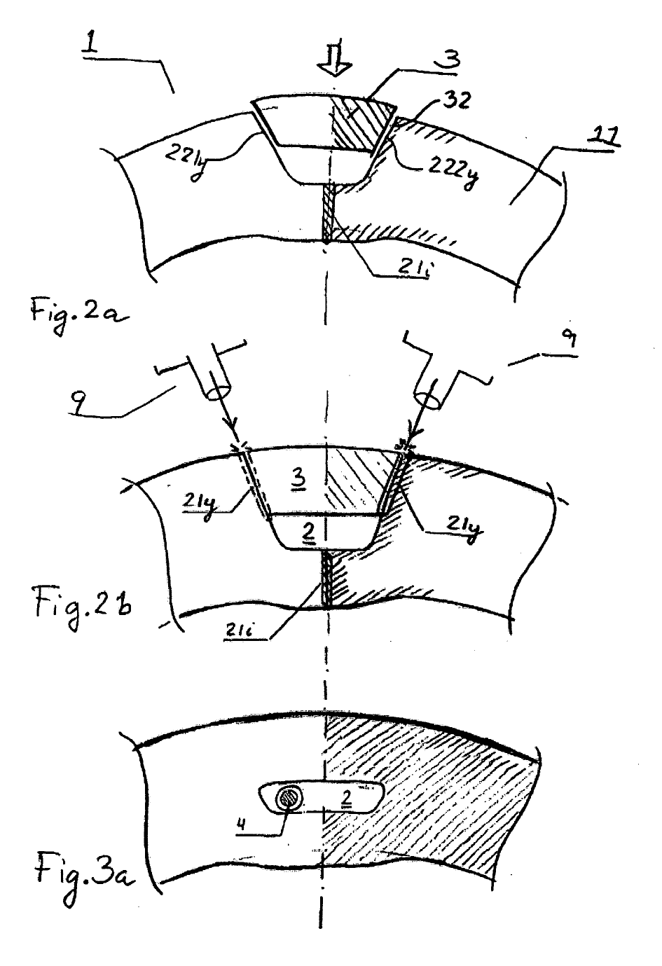

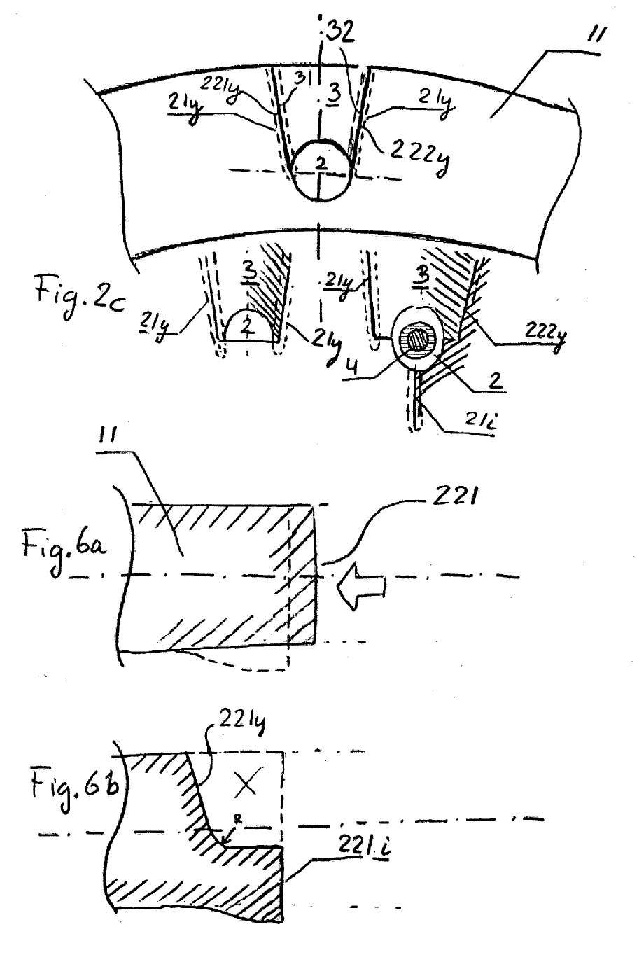

one may in a first preferred embodiment of the invention arrange an elongate metal lid (3), in the groove (22) such that a pipe canal (2) is formed in a radially lower or inner part of the groove (22), see FIG. 2a. The lid (3) is preferably of the same steel composition as for the steel plate (11) of the roll-formed pipe (1). The lid (3) may be milled.

welding two lateral edges, or more precisely defined, two lateral surfaces (31,32) of the lid (3) is made, to at least the radially outer portions of the adjoining sides (221u, 222y) in the groove (22), see FIG. 2b. Depending on the material composition and the use of the pipe with the pipe canal (2) the entire or parts of the pipe with the lid may be toughened. In such a manner is a pipe canal (2) formed, arranged for containing one or more conductors, for instance electrical or optical conductors, or hydraulic pipes formed in the pipe wall. The pipe canal may in itself form an hydraulic conduit or electromagnetic conductor for guided waves.

It is possible to use an alternate embodiment of the invention with “Y” shaping of the plate edges before the roll-forming of the hollow-body which shall be welded to form a pipe. This is described below under the discussion of FIG. 7 and FIG. 11.

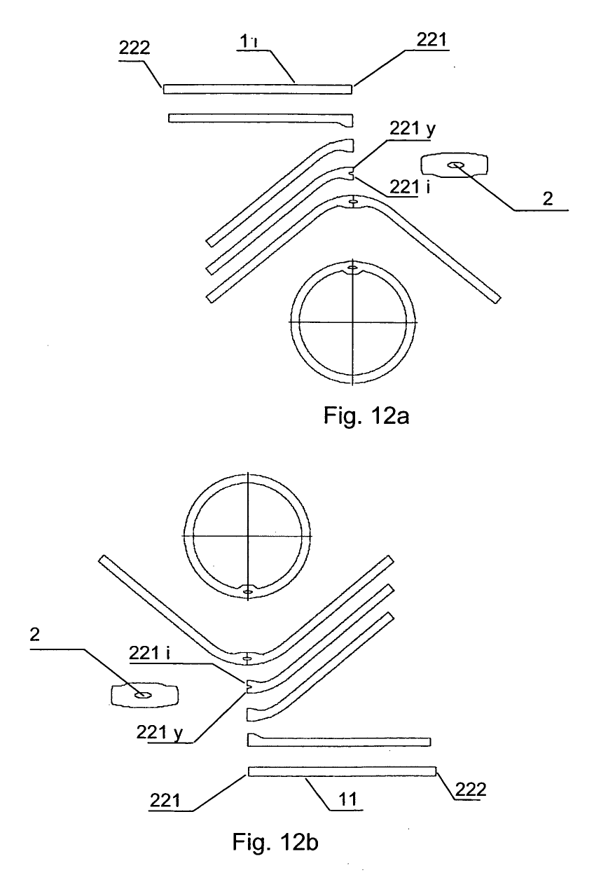

FIG. 12a shows an alternative preferred method according to the invention comprising two steel plates (11) to be joined while forming said canal (2) before roll-forming to a tubular shape and welded to form a pipe (1). Either plates will preferably be upset in their lateral direction to increase the thickness of the plate material at adjacent lateral edges to be joined by welding. One or both of said upset lateral edges (221, 222) to be welded are provided with a groove (22, 22′) before the welding so as for the two plates after joining to form a single plate comprising a longitudinal canal (2) in the so formed plate. The plates are in this embodiment of the invention shown to be pre-shaped and bent before the lateral edges are welded together. The resulting plate is then roll-formed to a longitudinal hollow with a gap to be welded along an opposite side of the hollow relative to the canal (2) so as to form a pipe (1) with a longitudinal canal in the pipe wall.

FIG. 12b is equivalent to FIG. 12a, the difference between them being in FIG. 12b the roll-forming process occurs by bending the plates upwards, whereas in FIG. 12a the roll-forming occurs in a downwardly direction. FIG. 12 b shows the final weld being conducted on the top side of the hollow, which may be logistically simpler than having to conduct the weld at the lower side of the pipe as shown in FIG. 12a. In principle there is no difference by roll-forming either way, but in practice it will be more feasible to roll-form the plate to end up with the final welding process to take place along the gap near the top of the hollow. Other weld set-ups may also be envisaged as is evident to the person skilled in the art.

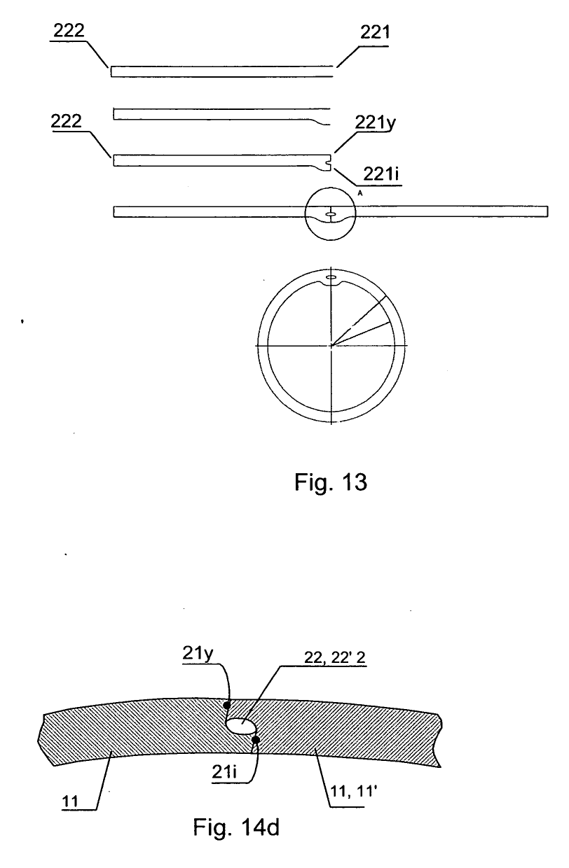

FIG. 13 shows more or less the same process as in FIGS. 12a and 12b, but in which the plates are not pre-shaped before the welding of the lateral edges of the adjacent steel plates. This embodiment of the invention may in some circumstances be easier to conduct than the ones shown in FIGS. 12a and 12b.

It is also evident for a person skilled in the art that more than two steel plates (11) being furnished with grooves (22) may be joined, and the entirety roll-formed to form a pipe comprising multiple canals in the pipe wall.

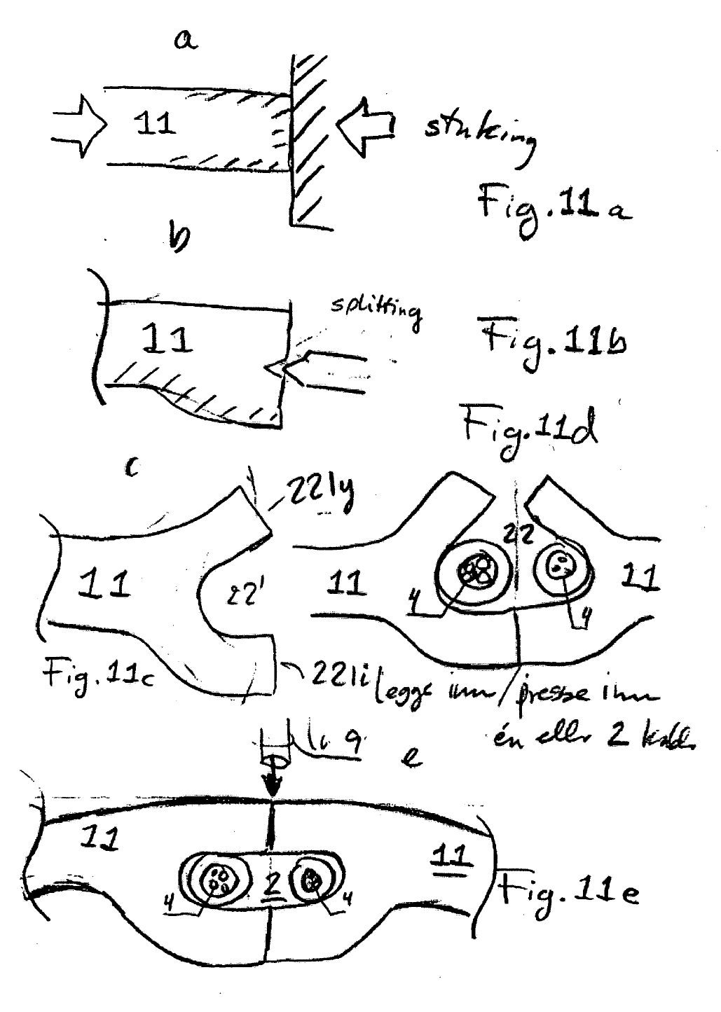

According to a first preferred embodiment of the method according to the invention, the method comprises formation of outer and inner pipe couplings (12, 13) at both ends of the pipe (1) for formation of a drilling pipe or casing, having a transition from the formed pipe canal to adjoining pipe canals (2′, 2″) at adjoining pipe couplings (13′, 12′), (13″, 12′) to adjoining drilling pipes or casings (1′,1″) at one or both ends of the pipe (1). Such a drilling pipe is illustrated in FIG. 5 and in FIG. 8A, 8b, FIG. 9 and FIG. 10. In a preferred embodiment this is performed by laser welding the end pieces in a machined, completely finished and toughened condition to a pipe manufactured according to the invention. In an embodiment of the invention in which one shall form a connection directly from a pipe canal (2) to adjoining pipe canals (2′, 2″) it might prove necessary that the pipe couplings (13, 12), (13′, 12′), (13″, 12″) are arranged such that the pipe canals (2,2′) or (2,2″) eventually align, for instance by arranging threaded pipe couplings (13, 12), (13′, 12′), (13″, 12″) such that the pipe canals align at a specified moment when tightening the threads. In other embodiments of the invention in which one has an inductive coupling at each end of the pipe canals (2, 2′, 2″) one is not in the same way dependant on the pipe canals aligning after tightening.

The advantages of laser welding the end pieces in machined, completely finished and toughened condition to a pipe produced according to roll-forming according to the invention is that laser welding takes place quickly and supplies less heat energy such that the result is that the metal is less negatively affected by the welding.

Laser welding of the end pieces according to the present invention will not be destructive for the transition between a canal in the wall of the pipe to an adjoining canal in the tool joint. A further advantage of the use of laser welding will be an increase in the tolerance of the produced drilling pipes. A drilling pipe according to the invention will be lighter and/or have as high or higher strength, and will thus allow an increase in the drilling lengths by the yield strength being augmented.

An alternative to laser welding of the tool joint end pieces may be the use of so-called electromagnetic welding (see FIG. 10) when mounting the tool joint (12, 13) onto the pipe (1). One of the parts may be outwardly conically bevelled, and the other parts may be correspondingly formed having a conically inwardly end surface and junction by discharge of an electrical coil about the weld locality such that one achieves a negligible heat influence on the metal around the weld.

At the transition from the main part of the pipe to the tooljoint (12, 13) the lid may be ended a short distance from one end of the seam (22), see FIG. 8, and an end surface (11f) of the pipe (1), and in which an end surface (12f) of the tool joint (12, 13) is laser welded to the end surface (11f) such that a pipe canal (2b) is arranged aligned with the pipe canal and the seam (22). A short lid (3) having mainly the same profile as the lid (3) is welded into the end of the seam between the end of the lid (3) and the tooljoint (12,13). The end of the lid (3) against the short lid (3e) may be shaped having a root welding support such that one does not risk burning through a possible inserted cable in the pipe canal (2) when welding into place the short lid (3e).

One of the parts, preferably the tooljoint (12, 13) may be shaped outwardly conically, see FIG. 9, with a possible sleeve-shaped root support (12h,13h) innermost against the central main bore (7) to abut against the bottom when laser welding, and the other part may be shaped correspondingly conically internally such that one achieves a deeper welding seam, and thus a larger weld surface between the pipe (1) and the tooljoint (12, 13).

A pipe produced according to the method according to the invention may comprise one or more of the following kinds of pipe:

Drilling pipes for drilling of geological wells, in which the drilling pipes are sectioned and preferably furnished with threaded pipe couplings, usually having a larger diameter than the main section of the pipe, and usually furnished with one set of outer and one set of inner conical threaded portions.

Casing pipes for the casing of drilled wells, in the same way formed as pipe sections and having threaded pipe couplings.

production pipes for the completion of wells, or

coiled tubes for insertion into wells, or

all-welded or sectioned pipelines, or

sectioned risers for the transportation of fluids.

After the welding in of the lid (3), the lid and at least the adjoining parts of the profile are toughened until it all has mainly the same microstructure, see FIG. 3. After a moderate tempering the material is homogenous and the influence of the welding is reduced considerably. In such a way the welds will not function as crack initiators. This is important as the pipe is subject to fatigue. By the toughening the yield stress becomes approximately 1100 MPa. The material should be so-called Boron-steel with about 0.2 per mil of Boron. The Boron steel may be toughened due to the B content. Boron was previously used as a substitute for Molybdenum and Chrome, but it turned out to be difficult to achieve an elevated tensile strength due to the small amount of B and thus it was difficult to distribute the small addition of B in a sufficiently uniform manner in the entire steel melt. The Boron steel has several advantages, it has a high tensile limit and a high rupture limit after toughening, it is easily roll-formable in the warm rolled condition in which it may achieve a tensile strength of about 320 MPa. The amount of Boron ensures that especially quick cooling when toughening is not needed. The Boron steel dissipates quickly the relatively small amount of heat from the steel when laser welding. The Boron steel may have the following composition in addition to iron (Fe):

| Component | Weight percentage |
|---|---|
| Carbon (C) | 0.2-0.25 |
| Silicon (Si) | 0.2-0.35 |
| Magnesium (Mn) | 1.0-1.3 |
| Phosphorous (P) | 0.0-0.03 |
| Sulphur (S) | 0.0-0.025 |
| Chrome (Cr) | 0.15-0.25 |
| Boron (B) | 0.003 |

The weld seam which preferably is laser welded is during cooling partly toughened and homogenised with the remainder of the steel plate. A high tensile yield may be achieved during the process after the welding of the pipe with the pipe canal in the pipe wall by heat treating to about 920° C., e.g. by means of induction coils, and subsequent rapid cooling by means of water nozzles, vapour nozzles, air nozzles, water baths or oil baths. By heat-treating and toughening the tensile yield may be increased from about 320 MPa to a minimum of about 1100 MPa, the breaking stress to a minimum of about 1500 MPa, and the steel achieves a large impact resistance.

In FIG. 3 and FIG. 4 the pipe canal or “hole” (2) is oval but it may have different shapes and diameters depending on the desire for the pipe wall strength vs. the need for diameters and shapes of cables (4) to be arranged in the pipe canal. By making the lid arched the idea is that the cross-section over the pipe canal (2) shall be mainly as large as in the rest of pipe wall.

FIG. 5 illustrates a cross-section longitudinally along the pipe (1) with the canal (22). An inductive coupling may be arranged at an outer extreme of the external threaded portion of the pipe end, and a corresponding inductive coupling at the inner end of the internal threaded portion of the pipe end. These threaded portions of drilling pipes are usually conical. In the same way the invention may also pertain to well casings etc for casting in wells. A drilling pipe in the shape of a drilling pipe section having two tooljoints (12,13) according to the invention may have a pipe diameter of about 5 inches, that is to say about 127 mm, and a wall thickness of about 10 mm. The material that is used today is stainless nonmagnetic steel.

According to an alternate embodiment of the invention the formation of the longitudinal trace or groove (22) having lateral edges (221, 222) use as a basis a complete pipe (1) which may be produced in a different manner than by roll-forming and welding for instance by deep drawing, and in which the groove (22) is formed by milling, cutting, pressing, forging or other mechanical shaping or by laser welding.

According to an advantageous embodiment of the invention the groove (22) is formed such that it tapers off towards the bottom, see FIG. 1D and FIGS. 1 and 2.

According to a preferred embodiment of the method according to the invention, the elongate lid (3) has a cross-section that conically tapers inwardly, as seen radially, and has its greatest width mainly corresponding to the width of the outer part of the groove (22) seen radially, i.e. the separation between the lateral surfaces (221y, 222y) to be connected. Thus the lid (3) fits into the trace (22) and one may weld it in preferably by laser welding without using soldering material in the weld. The intensity of the weld beam is adjusted to the desired depth of the surfaces in the contact area between the lateral surfaces of the lid and the lateral surfaces of the trace.

The groove or trace (22) may be concave, see FIG. 1d. In the same way it may be advantageous to shape the lid (3) so that the inwardly facing surface that forms the outer wall of the groove or trace (2) is inwardly concave towards the pipe canal (2) that is formed.

Furthermore it is an advantage to produce the lid (3) such that it bottoms out in the trace (22), see FIG. 2c, and is inwardly concave seen radially, such that one achieves, as counted radially, a longer welded surface against the lateral edges (221, 222) and that one reduces stress concentration, that is to say a sharp edge in the transition between the lid and the lower parts of the groove (22).

FIG. 2C shows a cross-section of the pipe wall (11) with the pipe canal (2) with the lid (3) in three alternate embodiments with convex inner areas. If the lid (3) is shaped with a convex inner area, deep lateral surfaces (31, 32) of the lid (3) are formed such that one may form deeper weld seams (21y, 21y) ? by laser welding. The concave inner area of the lid may be shaped in several manners as shown. In a first embodiment of the concave lid, the lid's inner area forms an arched roof over the entire width of the groove (22) and preferably the lid's inner lateral edges, as counted radially, align with the lateral edges of the bottom of the groove, which may preferably be shaped as a half-pipe. In another embodiment the lid's arched under area may be somewhat narrower and be furnished with “shoulders” that bottom out against corresponding shoulders in the bottom of the groove. In this way a root support for the laser weld is formed and may allow burning slightly deeper than the shoulder in the bottom of the lateral surface of the groove, a weld that in any case may be toughened away by subsequent heat-treatment and toughening. Two embodiments of the bottom are shown, one flat, and one with a shape as a half-pipe having shoulders which correspond to the shoulders on the underside of the inner area of the lid.

According to a preferred method according to the invention, further mechanical shaping of the entire or parts of the pipe profile (1, 11, 21i, 21y, 2) may be performed to achieve the desired outer or inner pipe profile. For instance one may mill off some material of the lid in order to shape a desired circular cross-section on the surface of the pipe. One may forge the pipe or it may also be polished, which may be required for coil tubing. It may for instance be undesirable for a drilling pipe to have any exterior bulb in the portion that is formed by the affixed lid after toughening. This is due to the fact that an exterior bulb on a drilling pipe may cause problems in blow-out valves and may incur undesirable friction during rotation in a bore hole, in particular during directional drilling in which the bore pipe wall may skid against the bore hole wall and in which an external bulb would cause undesirable vibrations and rotational resistance. This may be solved by changing the shape of the cross-section by upsetting the lateral edges (221, 222) of the plate (11) down before one begins the roll-forming of the pipe to be formed, so as for the inner diameter in the area adjacent to and directly below the weld (21) to be reduced such that the inner pipe wall forms an inward bulb or thickening towards the main bore of the pipe. We have indicated above that as a pipe produced according to the invention may have a substantially increased material strength, for instance an 18% increase, and thus have a substantially thinner wall thickness than drilling pipes produced according to common art without roll-forming and thus have a larger inner cross-sectional area of the main bore (7) and thus have a larger transport capacity e.g for drilling fluids and result in a reduced pressure loss when circulating drilling fluids during drilling. A major advantage of a pipe according to the invention will be the absence of an electrical cable in the main bore, which may partly block the passage of drilling fluids, possible rock fragments, tools or other devices in the drilling pipe's main bore.

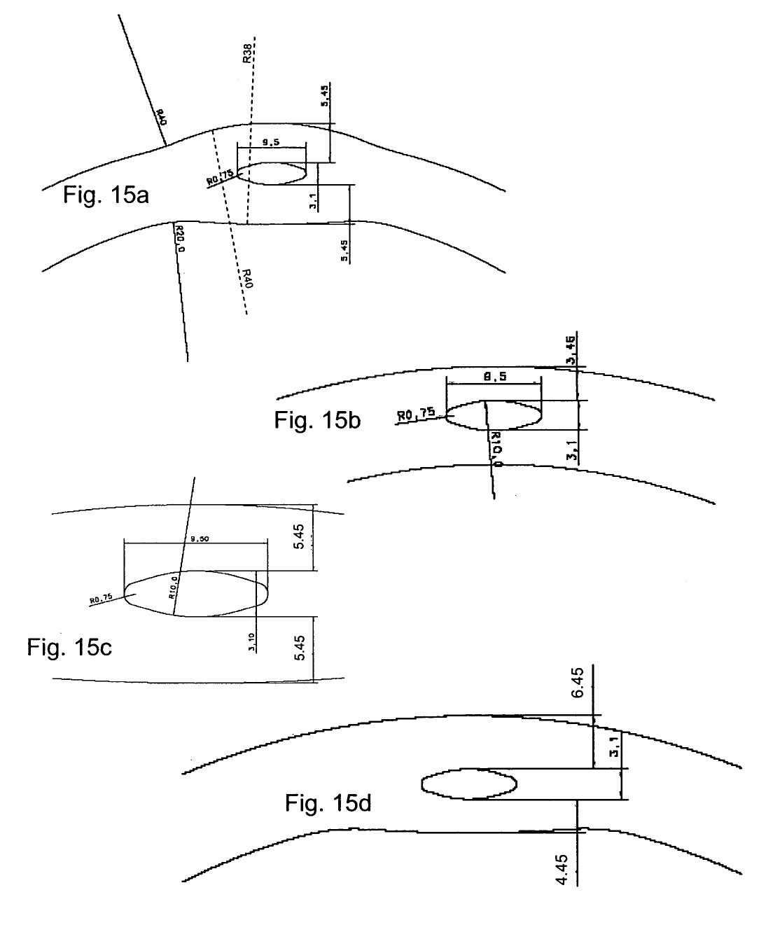

Coil tubing should be polished or otherwise surface processed to become smooth to easier pass a high pressure stuffing box and should have a circular cross-section in its straightened condition as illustrated in FIG. 13 or in FIGS. 15b, c, and d.

According to a an advantageous embodiment of the invention, an annealing and toughening of the pipe wall (11), the seams (21i, 21y) and the lid (3) should be performed in order for the pipe profile to have a generally homogenous microstructure.

According to a first aspect of the invention, the pipe (1) produced according to the invention may be utilised for the transmission of electromagnetic signals or for transmission of electrical energy between an installation on the Earths or the seas surface or the sea floor and a petroleum well during drilling or production from a well, in which said pipe (1) is used as a drilling pipe or a coil tube, a well casing, a riser or a pipeline.

According to a second aspect of the invention, the pipe (1) produced according to the invention may be utilised for the transmission of optical signals between an installation on the Earth's or the sea surface or the sea floor and a petroleum well during drilling or production from a well, in which said pipe (1) is used as a drilling pipe or a coil tube, a well casing, a production pipe, a riser or a pipeline.

According to a third aspect of the invention, the pipe (1) produced according to the invention may be utilised for the transmission of hydraulic pressure energy or hydraulic signals or for transportation of fluids in the pipe canal (2) between an installation on the Earths or the seas surface or the sea floor and/or a petroleum well during drilling or production from a well, in which said pipe (1) is used as a drilling pipe or a coil tube, a well casing, a production pipe, a riser or a pipeline.

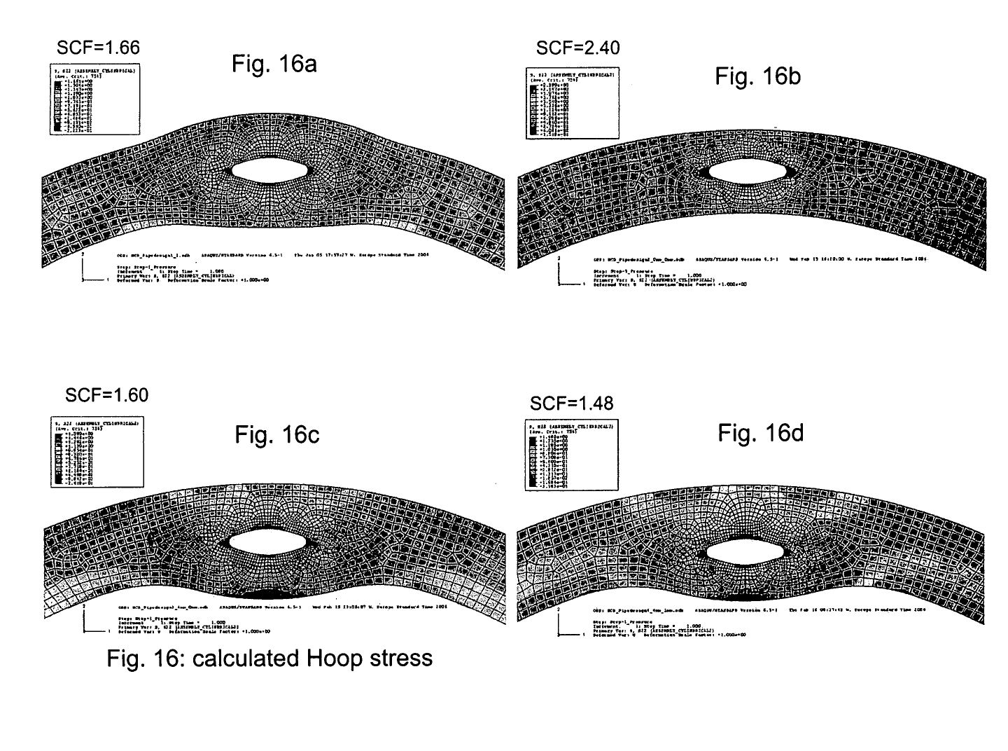

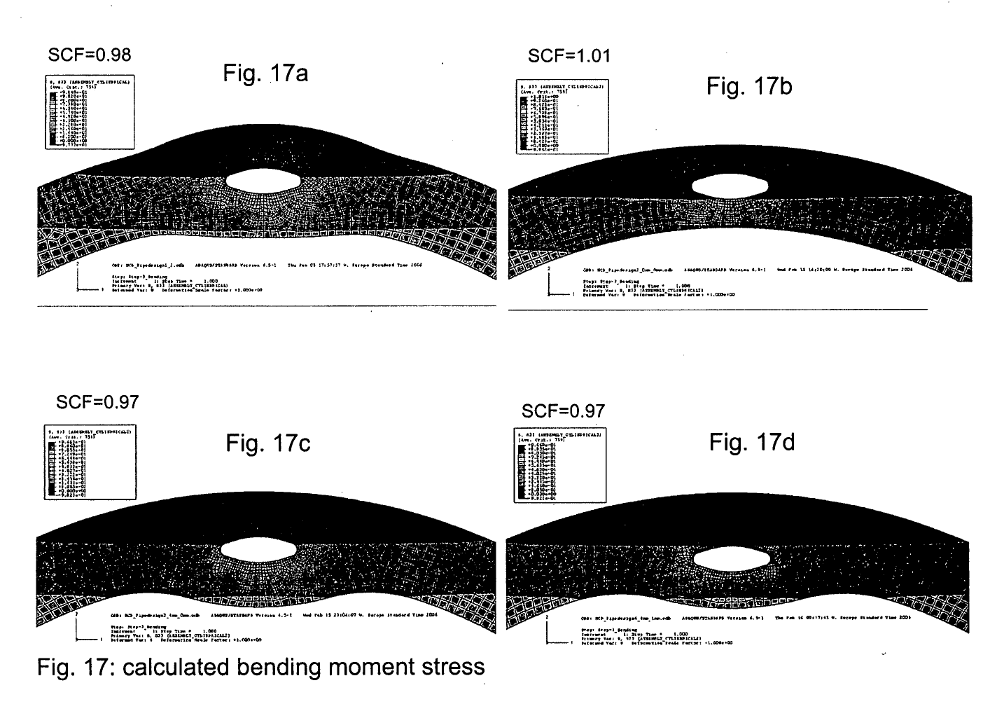

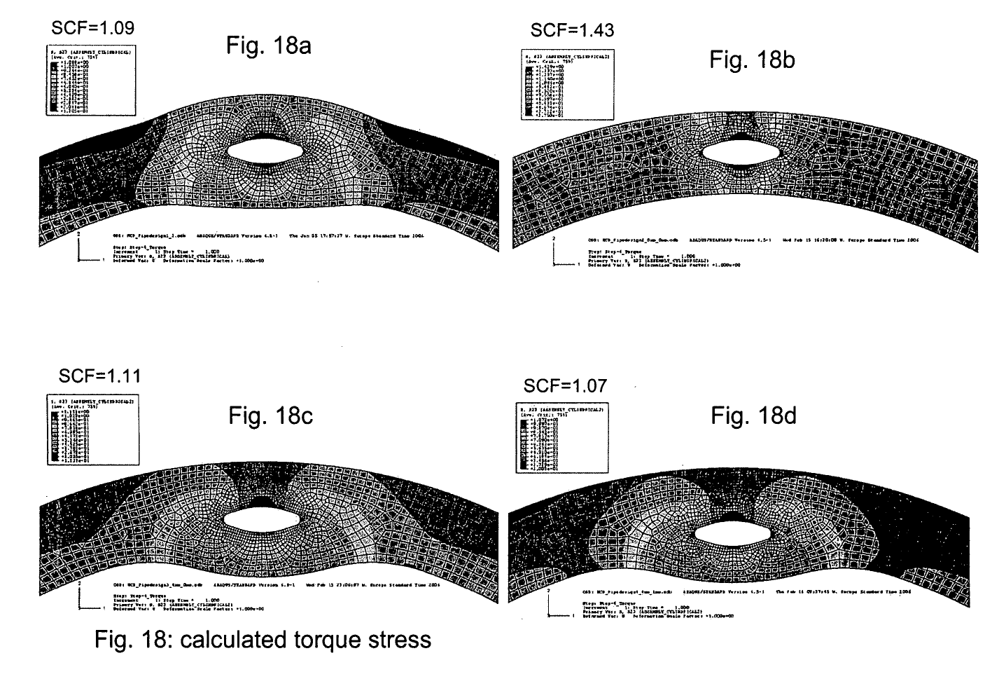

A longitudinal hole in the wall in a pipe, in which the pipe wall is of constant thickness may represent a substantial weakening of the pipe wall, either with respect to inside and external pressure strength, bending moment strength and torsional strength, please refer to FIGS. 16b, 17b, and 18b. Such a constant wall thickness is illustrated in FIG. 15b. The material cross-section which is formed in the cross-section of the pipe (1) through the join (21) and the lid (3) may thus in a preferred embodiment of the invention be larger than or as large as the material cross-section through the wall (11) of the pipe (1) outside the pipe canal (2), see FIG. 3, FIG. 3a, FIG. 7f and FIG. 11e, and also in FIGS. 15c and 15d. The improved strength characteristics are illustrated in FIGS. 16a, c and d, and in FIGS. 17a, c, and d, and finally in FIGS. 18a, c, and d.

In those occurrences in which the wall thickness of the pipe (1) is so large compared to the diameter of the pipe canal (2) that one does not need to take into account the weakening represented by a pipe canal in the wall, the material cross-section which is formed in the cross-section of the pipe (1) through the seam (21) and the lid (3) is made lesser than the material cross-section through the wall (11) in the pipe (1) aside of the pipe canal (2).

It is a premise for the toughening of pipe (1) produced by the method, that the material comprised in the plate (11) and the lid (3) are metal alloys that may be toughened. It is also a premise that the material comprised in the plate (11) and the lid (3) are metal alloys being corrosion resistant under those chemical conditions and pressures under which the pipe shall be used, for instance during drilling. The metal alloy comprised in the plate (11) and the lid (3) must also be highly malleable for instance during cold-forming.

It is possible to form the pipe canal (2) in an alternative manner by conducting a different shaping of the lateral edge surfaces before the roll-forming and welding. FIG. 7 shows a series of sketches of the working of at least one of the lateral edges (221, 222) of the steel plate (11) for forming a “half” groove (22′) in the lateral edge before roll-forming of the steel plate (11) to a hollow body, and welding to a pipe (1) having a pipe canal (2).

FIG. 7A shows splitting of the lateral edge (221) of the plate such that a groove (22′) is formed with a future radially inner bridge part (23) and a future radially outer lid portion (3′).

FIG. 7B shows working and shaping of the inner bridge part (23), as radially counted, such that it receives an inner lateral edge surface (221i) as radially counted, arranged for being welded to its counterpart (221i) formed on the opposite side of the steel plate (11).

FIG. 7C sketches a step after the roll-forming of the steel plate (11) for the formation of the hollow-body, in which the formation of a weld (21i) is made, preferably by laser welding of the radially inner bridge parts (23) inner lateral edge surface (221i) to its counterpart (222i) formed on the opposite side of the steel plate (11).

FIG. 7D sketches shaping of the radial outer lid parts (3′) such that their ends are shaped to be future outer lateral edge surfaces (221y, 222y), as radially counted, arranged for being bent inwardly towards the groove (22) that has been formed by the welding of the inner bridge parts (23, 23) as radially counted.

FIG. 7E shows the outer lid parts (3′, 3′) bent down towards the groove (22) such that their end surfaces (221y, 222y) form the steel plate's radially outer lateral edge surfaces for the formation of a weld (21y) to its counterpart for closing the groove (22) to a pipe canal (2).

FIG. 7F illustrates heat-treatment and toughening of at least the weld seams (21i, 21y) and preferably the entire pipe (1) with the pipe canal (2) such that the entire pipe with the portions lateral to the pipe canal receives a mainly similar microstructure.

It may be desirable to insert a conductor (4) into the groove (22) early in the process according to the invention as it may be difficult or impossible to draw such a conductor in the pipe canal due to friction or the conductor's mechanical properties makes it difficult or infeasible to pull such a conductor (4) through the pipe canal (2). If one lays a conductor (4) into the groove (22) such that one achieves friction contact between the conductor's possible isolation or shell, one may make the conductor lie in place so as for the conductor not to be subject to tension forces due to its proper weight, which is relevant when vertically running the pipe (1), for instance during mainly vertical drilling. It may, according to the method of the invention, before the step of placing the lid (3), be put an electrical or optical cable (4) or hydraulic pipe into the trace or groove (22), see FIG. 2c, with subsequent mounting of the lid (3) and laser welding of the lid's lateral surfaces by welding of the lid's (3) two lateral surfaces (31, 32) to the at least outer portions of the adjoining sides (221, 222) in the trace (22) seen radially. It may also be of interest to insert one or more conductors (4) before the welding in of the lid (3) in situations in which one desires to have such a large cable concentration in the pipe wall (2) that a cable or bundle of cables is impossible to draw through the pipe canal (2). This solves the problem of a drawn cable (4) in the main conduit (7) not being able to hold its own weight in for instance coiled tubes, and in which the cable must be attached point by point to be kept in place. It may also be of interest to insert a cable (4) in the groove (22) before welding of the alternate embodiment of the invention shown in FIG. 7, in which one may insert the cable (4) to the side of the weld seams to avoid damaging the cables by laser welding.

In a preferred embodiment of the method of the invention the process of putting into place the cable (4) before the welding in of the lid (3) may further take place during the formation of a single continuous and very elongate pipe (1) having a mainly equally elongate lid (3) for the formation of a coiled tube (1) with a cable (4) in a pipe canal (2) in which the coil tube may have a length of between about 50 metres and about 10 to 20 km, or a pipeline (0) with a cable (4) in a pipe canal (2) in which the pipeline may have a length of between about 1000 metres and 50 km.

Different ways are known about how to provide an electrical cable or optical fibre (4) through a pipe canal (2) according to the invention. Drilling pipes are relatively short, between 10 and 20 metres and there are no noticeable problems in threading a draw wire by blowing or pumping and later pull the desired conductor (4) through the pipe canal (2). By use of for instance a sectioned drilling string, a continuous coil pipe or a continuous or sectioned production pipe with a pipe canal in the pipe wall according to the invention, in which the pipe is placed into operative position in the well, one may feed and pump down the conductor (4) itself, for instance a relatively stiff optical fibre bundle from the surface and down to the desired depth in the well.

A pipe with a pipe canal according to the invention may also be used as a production pipe for the completion of wells. Thus one may either have electrical or optical fibres in the pipe canal (2) to communicate with measurement instruments in the production zone or higher up in the completed well. For instance one may arrange chemical compounds at the exterior of the production pipe in the well at the production zone, in which the chemical compounds are arranged for reacting with penetrating chemical compounds for the reservoir rock formations, for instance by releasing specified tracers at the penetration of water (pore water, brine) into the completed well. However at present there is a problem of lacking calibration for water penetration as it is difficult to supply water of the desired quality to the production zone when the chemical compounds are placed on the production pipe without temporarily shutting down production. This may be solved by using a production pipe manufactured with a pipe canal in the pipe wall, and pump down desired chemical substances through the pipe canal in the pipe wall to a desired depth in the production well while the production otherwise continues uninterrupted, for instance by the pumping down of calibration water, e.g. water that one presumes to have the same composition as intruding pore water, to the production zone for testing the release of tracers to the produced oil by undesired intrusion of such water.

When drilling it may be an advantage to use a drilling pipe (1) in which one has a circular cross-section in the surface of the drilling pipe, such as is shown in FIG. 2C, FIG. 3a and in FIG. 11e. During operations in a “live” well, blow-out preventer valves will be used, the blowout preventer valves having rubber elements that continuously seal along the pipe string, and on which coupling joints shall pass through the rubber elements. The pipe couplings must pass through to cooperating valves with rubber elements in which at least one of them must at all times seal during the passing of the pipe coupling on the way up or down. It would greatly simplify the operation should activation of the rubber elements not depend on the pipes outer cross-section, but solely of pipe couplings that shall pass through.

FIG. 11a-FIG. 11E shows production of a pipe having a constant outer diameter and the possibility for inserting a cable into such a pipe, which would provide a drilling pipe or coil pipe or other type of petroleum pipe having great advantages.

FIG. 11A shows upsetting of the plate edge (221) such that a bulb is formed on the side of the plate the plate edge (221i) that in future is going to form the inner surface of the pipe.

FIG. 11B shows the splitting of the plate edge and FIG. 11C shows the shaping of said plate edge (221i) which shall be welded subsequent to the roll-forming of the pipe hollow-body.

FIG. 11D shows a possible inserting or pressing into of a cable with an optical or electrical conductor in the formed groove (22).

FIG. 1E shows welding of the outer part of the plate edge (221y, 222y) for closing the groove (22) and formation of the pipe canal (2). It is here shown an aligned outer surface of the pipe (1) in which the bulb due to the formation of the pipe canal formation is shown on the inside of the pipe wall. Such a pipe with a pipe canal having an aligned circumference is usually conditional for coiled pipes.

FIG. 12a shows an alternative preferred embodiment of the invention comprising two steel plates (11, 11′) to be joined before roll-forming to a tubular (0) shape and welded to form a pipe (1). Either plates are upset at their lateral edge surfaces (221, 222) to increase the thickness of the plate material at adjacent lateral edge surfaces (221, 222) to be joined by welding. One or both of said upset lateral edges (221, 222) to be welded are provided with a groove (22) before the welding so as for the two plates after joining to form a single plate (11) comprising a longitudinal canal (2) in the so formed plate. The plates are in this embodiment of the invention shown to be pre-shaped and bent in the vicinity of the upset edge with the groove (22) before the lateral surfaces are welded together to form the canal (2). The remainder plane portions of the resulting welded plate is then roll-formed to a longitudinal hollow with a gap to be welded along the opposite side of the pipe relative to the formed canal (2) in the hollow so as to form a pipe (1) with a longitudinal canal (2) in the pipe wall. In this manner, the so formed canal (2) is very little affected by the roll-forming process.

FIG. 12b is equivalent to FIG. 12a, the difference between them being in FIG. 12b the roll-forming process occurs by bending the plates upwards, whereas in FIG. 12a the roll-forming occurs in a downwardly direction. FIG. 12 b shows the final weld being conducted on the top side of the hollow, which may be logistically simpler than having to conduct the weld at the lower side of the pipe as shown in FIG. 12a. Other roll-forming and weld set-ups may also be envisaged and would be evident to the person skilled in the art.

FIG. 13 illustrates a process similar to FIG. 12a and FIG. 12b, but in which the set-up lateral edge surface of the plate is not roll-formed before the weld-joining of the two set-up and furrow-formed lateral edge surfaces. This embodiment of the invention may in some circumstances be easier to perform than the ones shown in FIGS. 12a and 12b.

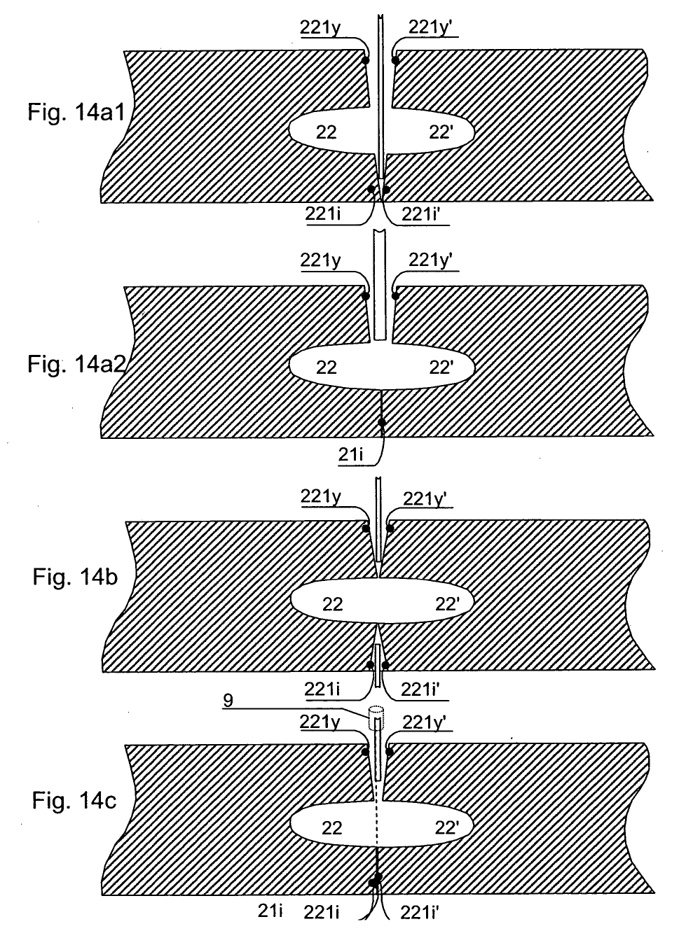

FIG. 14 illustrates three additional alternative welding methods for forming a canal in a pipe wall.

FIGS. 14a1 and 14a2 are cross-sections perpendicular to the axis of the pipe or the longitudinal axis of the plate or plates, showing that both the inner and outer gap may be “V”-shaped and welded from one side using additive material. This embodiment of the invention may be convenient if the canal along the axial direction of the plate shall be formed subsequent to the roll-forming process. In FIG. 14a1 the lower adjacent lateral portions (221i, 222i) are welded from the upper/outer side by adding material forming an inner bridge portion with a welded zone (21i), and in FIG. 14a2 the welded zone (21i) has been formed, and the outer lateral portions (221y, 222y) are welded using an additive material spanning the lateral portions (3′, 221y, 3′, 222y) to form a bridging lid portion (3) thus forming the desired canal (2) in the axial direction through the wall of the pipe formed.

FIG. 14b is a cross section as in FIG. 14a, illustrating that the adjacent lateral portions of the plate or plates about the adjacent furrows forming parts of the canal to be formed may formed as opposite “V”-shaped furrow sides to be welded using additive welding material from both sides of the plate. This embodiment of the invention may be useful if the canal along the axial direction of the plate shall be formed prior to the roll-forming process.

FIG. 14c is an illustration of the combination of laser welding and conventional additive material welding. Tightly fitting inner lateral surfaces (221i, 222i) of lower bridge portions (23′, 23′) of the steel plate are laser welded below the formed furrows (22, 22′) using a laser (9) forming the welded zone (21i), and subsequently the outer lateral portions (221y, 222y) are welded using an additive material spanning the lateral portions (3′, 221y, 3′, 222y) to form a bridging lid portion (3) thus forming the desired canal (2) in the axial direction through the wall of the pipe formed. This embodiment of the invention may be useful if the canal along the axial direction of the plate shall be formed after to the roll-forming process.

FIG. 14d is an illustration of a joint of the two lateral surfaces having two oppositely formed grooves (21, 21′) with weld seams symmetrically arranged about the so formed canal (2).

FIG. 15 illustrates cross-sections of parts of pipes according to the invention, the pipes having different geometries of a welded zone of the pipe seams about the formed canal (2). The illustrated pipe sections all have a nominal pipe outside diameter of 146 mm with a wall thickness of 10 mm. The formed canal (2) of each is of approximately elliptical cross-section having a long axis of 9.5 mm and a short axis of 3.1 mm, with a largest radius of 10 mm and a smallest radius of 0.75 mm.

FIG. 15a illustrates the channel (2) being radially centred 5.45 mm from the inner and outer surfaces resulting in a material thickness of 10.9 mm over the channel. The extra material results in a non-circular surface both on the outside and inside of the pipe (1). The outer bulge has a radius of 34 mm, and the inner bulge has a radius of 38 mm.

FIG. 15b illustrates a pipe with even outer and inner radii across the cross-section of the canal (2), thus the material thickness of the pipe wall is 10 mm minus 3.1 mm=6.9 mm across the canal (2). This incurs a slightly increased stress across the canal cross-section, but the circular shape is advantageous with respect to operation and transportation.

FIG. 15c is a section across the canal (2) over which the outer surface of the pipe is flush with the pipe radius, and in which the inner surface of the pipe wall forms a bulge into the main channel of the pipe. The canal (2) is in the middle of the wall and the material thickness radially inside of and outside of the canal is equal, here 4.95 mm,

FIG. 15d is similar to FIG. 15c except in that the canal (2) is displaced 1 mm nearer to the centre of the pipe (1). The wall thickness outside of the canal is 6.45 mm and 4.45 mm inside relative to the canal.

FIG. 16 illustrates calculated Hoop stress distributions about a canal (2) in a pipe (1) as calculated using finite-element analyses. The finite-element analyses were calculated based on a 8-node linear brick elements given linear elastic material properties with Young's modulus of 205000 N/mm² and a Poisson ration of 0.3. The so-called stress concentration factors SCF have been calculated for the peak stresses calculated for each of the four cross-section models based on the nominal Hoop stresses of 1 N/mm² for the 10 mm thick inner wall. FIGS. 16a, b, c, and d are contour plots of hoop stress of sections of pipes corresponding to FIGS. 14a, b, c, and d, modelled for an internal pressure of 0.1462 N/mm² corresponding to a hoop stress of 1 N/mm² at the inner radius of the pipes. Please notice that the stress ranges change from one contour plot to another.

FIG. 17 illustrates calculated bending moment stress distributions about in a pipe (1) a with canal (2), calculated using finite-element analyses. The stress concentration factors SCF have been calculated for the peak stresses calculated for each of the four cross-section models based on the nominal bending moment stresses of 1 N/mm² for the 10 mm thick inner wall. FIGS. 17a, b, c, and d are contour plots of bending moment stress of sections of pipes corresponding to FIGS. 15a, b, c, and d, modelled for a bending moment 136 152 Nmm corresponding to a nominal axial stress of 1N/mm² at the outer radius of the pipes.

FIG. 18 illustrates calculated torque stress distributions about in a pipe (1) a with canal (2), calculated using finite-element analyses. The stress concentration factors SCF have been calculated for the peak stresses calculated for each of the four cross-section models based on the nominal torque stresses of 1 N/mm² for the 10 mm thick inner wall. FIGS. 18a, b, c, and d are contour plots of torque stress of sections of pipes corresponding to FIGS. 15a, b, c, and d, modelled for a torque of 272 304 Nmm corresponding to a nominal shear stress of 1 N/mm² at the outer radius of the pipes.

The results of the calculated stress concentrations factors SCF for Hoop stress, tension, bending moment, and torque, are given for the four cross sections as described under FIG. 15a with inner and outer bulges, 15b with slick circular inner and outer radii, FIG. 15c with slick outer pipe radius and radially central wall canal, and FIG. 15d with slick outer pipe radius and inwardly displaced wall canal relative to FIG. 15c.

| | Internal | | | |
|---|---|---|---|---|
| | pressure | | Bending | |
| | (Hoop stress) | Tension | moment SCF | Torque |
| | SCF max | SCF max | max | SCF max |
| | 1.66 | 0.99 | 0.98 | 1.09 |
| (i & o bulges) | | | | |
| | 2.40 | 1.01 | 1.01 | 1.43 |
| (slick i & o | | | | |
| | 1.60 | 0.99 | 0.97 | 1.11 |
| (slick centr.) | | | | |
| FIG. 15d (slick | 1.48 | 0.99 | 0.97 | 1.07 |
| w/displaced | | | | |
| canal inward) | | | | |

The results for axially directed tension, a stress concentration factor between 0.99 and 1.01 are negligible due to the canal (2) being directed parallel to the axial direction of the pipe, and are not illustrated.

Further, the contour plots of bending moments show stress concentration factors between 0.97 and 1.01, as shown in the table and in FIG. 17. These bending moment stress concentrations are also negligible.

The calculated hoop stress due to internal pressure incur the most significant stress concentrations factors. The design illustrated in FIG. 15 b for a slick pipe shows an SCF of 2.40. The design illustrated in FIG. 15a having both inward and outward bulges has a stress concentration factor of 1.66. Even better is the design with even circular outer surface section of the pipe, shown in FIGS. 15c and 15d, having stress concentrations of 1.60 and 1.48, respectively. Thus it significantly improves the hoop stress properties shifting the canal (2) 1 mm towards the pipe's center from the position in the middle of the pipe wall as in FIG. 15d relative to the radially centered canal (2) of the design shown in FIG. 15c. Thus all the circular outer surface designs shown in FIGS. 15b, c, and d should suitable for coiled tubing, the designs of FIGS. 15c and 15d being more suitable for high pressure intervention work in a well.

For torque, the stress concentration factors are as low as 1.09 for the outer bulge design of FIG. 15a. The otherwise advantageous cross-section designs of FIGS. 15c and 15d having a slick outer surface provide even better stress concentration factors of 1.11 and 1.07, respectively, and together with the fact that they have bending moment SCFs of only 0.97, and the fact that the steel pipe may be designed with significantly improved tensile properties as explained in the tensile property table in page 2, they should work well for petroleum well drilling purposes as compared to ordinary drillpipe without a canal in the pipe wall.

1. A method for forming a longitudinally extending canal (2) in an extended steel plate (11, 11′) during a roll-forming process for the manufacture of a pipe (1) for use in petroleum exploitation, the method characterized by the following steps:
forming a longitudinally extending groove (22, 22′) in one or both of longitudinally extending, adjacent opposite lateral edge surfaces (221, 222) of said one or more steel plates (11, 11′) to be joined,
thus forming a first bridge part (23, 23′) comprising a first lateral edge surface (221i, 222i) along a first side of said groove (22, 22′), and
thus forming a second lateral edge surface (221y, 222y) on a second, opposite side of said groove (22, 22′);
welding said first bridge parts' (23, 23′) first lateral edge surface (221i, 222i) to said adjacent opposite lateral edge surface (221, 222) thereby making said one or more grooves (22, 22′) constitute a bottom of said canal (2);
welding said second lateral edge surface (221y, 222y) to an opposite adjacent lateral edge surface (221, 222) to form a lid (3, 3′) for bridging said one or more grooves (22, 22′) to form said canal (2).

2. The method according to claim 1, in which
two steel plates (1,1′) being provided with said one or more grooves (22,22′), are welded together to form said canal (2) along the joint in the so formed plate (1,1′) before roll-forming said plate (1, 1′) to form a hollow (0′) with a longitudinal gap for being subsequently welded to form said pipe (1).

3. The method according to claim 1, in which
said one or more steel plates (1,1′) are roll-formed to a hollow (0′) with a longitudinal gap provided with said one or more grooves (22,22′), for being subsequently welded to form said pipe (1).

4. The method according to claim 1, comprising
joining said lateral edge outer surfaces (221y, 222y) by arranging an elongate lid (3) in said groove (22).

5. The method according to claim 4, comprising
welding two lateral edges (31, 32) of said lid (3) in order for two weld seams (21y) to be formed against said adjoining sides (221y, 222y) of said one or more grooves (22).

6. The method according to claim 1, comprising
shaping said lateral edge surfaces (221y, 222y) to constitute lateral surfaces on one or more radially outer lid portions (3′) for partially covering said one or more grooves (22);
welding said lateral edge outer surfaces (221y, 222y) in order for a weld seam (21y) to be formed between said adjoining sides (221y, 222y) of said one or more grooves (22) so as to form an elongate lid (3) covering said groove (22) to form said enclosed pipe canal (2).

7. The method according to claim 1, comprising
upsetting one or both of said lateral edge surfaces (221,222) of said plate (11) to increase the material thickness at least of said edge surfaces (221, 222) of said plate (11).

8. The method according to claim 2, comprising
partially bending a portion of said one or more plates (11, 11′) near the edge surface (221, 222) with the groove (22) to form a portion of said pipes (1) curvature before forming the canal (2).

9. The method according to claim 4, in which
said elongate lid (3) is made with a conical cross-section and has its largest width mainly corresponding to the breadth between the lateral surfaces (221y, 222y) to be connected.

9. The method according to claim 4, in which
said lid (3) bottoms out in said groove (22) and is internally concave.

10. The method according to claim 1, comprising
the formation of exterior or interior tooljoints (12,13) at either ends of said pipe (1) for the formation of sections of drilling pipe or casing pipe, with a transition canal (2b) from the formed pipe canal (2) to a corresponding adjoining pipe canal (2′) at adjoining tool joints (13′,12′) in an adjoining drilling pipe or casing (1′).

11. The method according to claim 10, in which
said lid (3) is terminated a small distance away from an end of said groove (22) near an end surface (11f) of said pipe (1) and in which an end (12f) of said tool joint (12, 13) is welded to said end surface (12f) of said pipe (1) such that a pipe canal (2b) is arranged aligned with said pipe canal (2) and said groove (22) and in which a short lid (3e) having mainly the same profile as said lid (3) is welded into the end of said groove (22) between the end of said lid (3) and said tooljoint (12,13).

12. The method according to claim 10, in which
said end surface (11f) of the main portion of said pipe (1) is made conically hollow, and a corresponding portion of said tool joint (12, 13) is made externally cone, so as for forming an increased welding interface between the pipe and the tooljoint.

13. The method according to claim 1, comprising
heat treating of the pipe wall (1) at least near the weld seams (21) in order for the entire pipe (1) to achieve a generally similar microstructure and preferably such that the pipe (1) and the welds (21) are hardened to achieve improved mechanical properties for instance with respect to tensile yield and impact resistance.

14. The method according to claim 1, in which
the material cross section formed in the cross section of said pipe (1) through said seams (21) and said lid (3) is made larger than or corresponding to the material cross section through the wall (11) in said pipe (1) outside said pipe canal (2).

15. The method according to claim 1, comprising
arranging an electrical or an optical conductor (4e, 4o) or a hydraulic pipe (4h) in said groove (22, 22′) with subsequent laser welding of said lid's (3) to bridge said groove (22, 22).

16. The method according to claim 15, in which
the process of inserting the conductor or cable (4) before the welding of said lid (3) is further conducted during the formation of a single and very elongate pipe (1) having a correspondingly elongate lid (3) for the formation of a coil tube (0) having a length of between approximately 50 meters and approximately 10 km-20 km, or a pipeline (0) having a length between 1000 m and 50 km.

17. A roll-formed pipe (1) made from one or more steel plates (11, 11′) for use in petroleum exploitation, said pipe characterised by
a longitudinal pipe canal (2) in the pipe wall, said pipe canal traversing a major proportion of the pipe's (1) length,
a first, inner weld seam (21i) along said pipe canal (2), said weld seam adjoining inner lateral surfaces (221i, 222i) of said steel plates (11, 11′),
one or more bridge parts (3,3′) adjoining outer lateral surfaces (221y, 222y) thus covering said pipe canal (2) at a radially counted outer surface of said pipe (1).

18. The pipe according to claim 17, in which
said one or more bridge parts (3,3′) constituted by an elongate lid (3) arranged abutting to and welded to said adjoining surfaces (221y, 222y).

19. The pipe according to claim 17, in which
said lateral outer surface edges (221y, 222y) extend above said groove (22), welded together in a weld seam (21y) thus forming said bridge parts (3,3′).

19. The pipe according to claim 17, having exterior or interior tooljoints (12,13) at either ends of the pipe (1) so as for constituting parts of a drilling pipe or liner, with transitions from the pipe canal (2) to adjoining pipe canals (2′) at adjoining tooljoints (13′,12′) in adjoining drilling pipes or well casings.

20. The pipe (1) according to claim 17 in which said pipe is arranged for use as one or more of
a drilling pipe for the drilling of geological formations, or
a well lining for the lining of drilled wells, or
a coil tubing for insertion into wells, or
production pipes for the completion of wells, or
a pipeline or riser for the transportation of fluids.

21. The pipe according to claim 17, in which
said pipe canal (2) in the pipe wall is arranged for containing one ore more signal conductors (4), for instance electrical or optical conductors (4e, 4o) for the transmission of electromagnetic signals or energy.

22. The pipe according to claim 17, in which
said pipe canal (2) in the pipe wall is in itself is a hydraulic or electromagnetic conductor.

23. The pipe according to claim 17, in which the material cross-section in the cross-section of said pipe (1) through the seams (21) and the lid (3) is at least as thick as the material cross-section through the wall (11) outside the pipe canal (2).
